(19) United States
(12) Patent Application Publication
(10) Pub. No.: US 2019/0250966 A1
(43) Pub. Date: Aug. 15, 2019

(54) SYSTEMS AND METHODS FOR PROCESSING REMOTE PROCEDURE CALLS

(71) Applicant: Nutanix, Inc., San Jose, CA (US)

(72) Inventors: Buchibabu Chennupati, Bangalore (IN); Amit Jambure, Bengaluru (IN)

(21) Appl. No.: 15/893,017

(22) Filed: Feb. 9, 2018

(51) Int. Cl. G06F 9/54; G06F 9/48; G06F 9/455

(52) U.S. Cl. CPC G06F 9/547; G06F 9/4856; G06F 2009/45583; G06F 2009/45579; G06F 9/45558

(57) ABSTRACT

This disclosure provides systems and methods for processing remote procedure calls (RPCs). A system can include a first service accessible via a first port and a second service accessible via a second port. The system can include an (RPC) broker coupled to each of the first port and the second port. The RPC broker can be configured to halt the second service at the second port and to restart the second service at a second redirect port. The RPC broker can also be configured to maintain a mapping associating the second port with the second redirect port.

### BACKGROUND

The following description is provided to assist the understanding of the reader. None of the information provided or references cited is admitted to be prior art.

Cloud computing architectures are widely used in a variety of applications. The underlying computer networks that support cloud computing can include hundreds or thousands of computing devices networked to form one or more clusters. In some instances, the computing devices may execute a large number of virtual machines. The virtual machines and the underlying hardware can communicate with one another via remote procedure calls (RPCs). However, due to the large number of virtual machines and computing devices that may make use of RPCs in such architectures, it can be difficult to provide simulation and test capabilities prior to deployment of a largescale network.

### SUMMARY

In accordance with at least some aspects of the present disclosure, a system is disclosed. The system can include one or more processors configured to execute a first service accessible via a first port, a second service accessible via a second port, and a remote procedure call (RPC) broker communicatively coupled to each of the first port and the second port. The RPC broker can be configured to halt the second service at the second port. The RPC broker can be configured to restart the second service at a second redirect port. The RPC broker can also be configured to maintain a mapping associating the second port with the second redirect port.

In some embodiments, the RPC broker can be further configured to forward a first RPC initiated by the first service at the first port and directed to the second service at the second port by receiving the first RPC from the first service via the first port and forwarding the first RPC to the second redirect port, based on the mapping. The RPC broker can also receive a response to the first RPC and forward the response to the first service at the first port. In some embodiments, the RPC broker can be further configured to determine a processing time for the first RPC. The processing time can correspond to the elapsed time between receipt of the first RPC by the RPC broker and receipt of the response by the RPC broker. The RPC broker can also be configured to store a record of the first RPC and the processing time of the first RPC in a database.

In some embodiments, the RPC broker can be further configured to halt the first service at the first port, restart the first service at a first redirect port, and maintain the mapping associating the first port with the first redirect port. In some embodiments, the RPC broker can be further configured to forward a second RPC initiated by the second service at the second port and directed to the first service at the first port by receiving the second RPC from the second service via the second port and forwarding the second RPC to the first redirect port, based on the mapping. The RPC broker can also receive a response to the second RPC and forward the response to the second service at the second port.

In some embodiments, the RPC broker can be further configured to receive a plurality of first RPCs initiated by the first service directed to the second service and a plurality of second RPCs initiated by the second service directed to the first service. The plurality of first RPCs and the plurality of second RPCs can correspond to an operation executed by the system. The RPC broker can also be configured to store a record of the plurality of first RPCs and the plurality of second RPCs corresponding to the operation in a database.

In some embodiments, the RPC broker can be further configured to receive a first RPC initiated by the first service and directed to the second service, discard the first RPC, and transmit a predetermined response to the first service via the first port. In some embodiments, the predetermined response can correspond to an error code associated with the first RPC.

In some embodiments, the one or more processors can implement a plurality of virtual computing devices. In some embodiments, the virtual computing devices can be executed by a plurality of nodes networked to form a cluster. In some embodiments, the first service and the second service can execute on a first one of the plurality of virtual computing devices. In some embodiments, the first service can execute on a first one of the plurality of virtual computing devices and the second service can execute on a second one of the plurality of virtual computing devices.

In accordance with some other aspects of the present disclosure, a method is disclosed. The method can be executed by a remote procedure call (RPC) broker communicatively coupled to a first service via a first port and to a second service via a second port. The method can include halting the second service at the second port. The method can include restarting the second service at a second redirect port. The method can include maintaining a mapping associating the second port with the second redirect port.

In some embodiments, the method can include forwarding, by the RPC broker, a first RPC initiated by the first service directed to the second service at the second port by receiving the first RPC from the first service via the first port and forwarding the first RPC to the second redirect port, based on the mapping. The method can also include receiving a response to the first RPC and forwarding the response to the first service at the first port. In some embodiments, the method can include determining, by the RPC broker, a processing time for the first RPC. The processing time can correspond to the elapsed time between receipt of the first RPC by the RPC broker and receipt of the response by the RPC broker. The method can include storing, by the RPC broker, a record of the first RPC and the processing time of the first RPC in a database.

In some embodiments, the method can include halting the first service at the first port, restarting the first service at a first redirect port and maintain the mapping associating the first port with the first redirect port. In some embodiments, the method can include forwarding, by the RPC broker, a second RPC initiated by the second service directed to the first service at the first port by receiving the second RPC from the second service via the second port and forwarding the second RPC to the first redirect port, based on the mapping. The method can also include receiving a response to the second RPC and forwarding the response to the second service at the second port.

In some embodiments, the method can include receiving, by the RPC broker, a plurality of first RPCs initiated by the first service directed to the second service and a plurality of second RPCs initiated by the second service directed to the first service. The plurality of first RPCs and the plurality of second RPCs can correspond to an operation executed by the system. The method can also include storing, by the RPC broker, a record of the plurality of first RPCs and the plurality of second RPCs corresponding to the operation in a database.

In some embodiments, the method can include receiving, by the RPC broker, a first RPC initiated by the first service and directed to the second service. The method can include discarding, by the RPC broker, the first RPC. The method can also include transmitting, by the RPC broker, a predetermined response to the first service via the first port. In some embodiments, the predetermined response can correspond to an error code associated with the first RPC.

In accordance with some other aspects of the present disclosure, a non-transitory computer-readable storage medium is disclosed. The non-transitory computer-readable storage medium can have instructions encoded thereon which, when executed by one or more processors of a remote procedure call (RPC) broker communicatively coupled to a first service via a first port and to a second service via a second port, cause the one or more processors to perform a method. The method can include halting the second service at the second port. The method can include restarting the second service at a second redirect port. The method can include maintaining a mapping associating the second port with the second redirect port.

In some embodiments, the method can include forwarding a first RPC initiated by the first service at the first port and directed to the second service at the second port by receiving the first RPC from the first service via the first port and forwarding the first RPC to the second redirect port, based on the mapping. The method can also include receiving a response to the first RPC and forwarding the response to the first service at the first port.

In some embodiments, the method can include determining a processing time for the first RPC. The processing time can correspond to the elapsed time between receipt of the first RPC by the RPC broker and receipt of the response by the RPC broker. The method can also include storing a record of the first RPC and the processing time of the first RPC in a database.

In some embodiments, the method can also include halting the first service at the first port, restarting the first service at a first redirect port, and maintaining the mapping associating the first port with the first redirect port. In some embodiments, the method can include forwarding a second RPC initiated by the second service at the second port and directed to the first service at the first port by receiving the second RPC from the second service via the second port and forwarding the second RPC to the first redirect port, based on the mapping. The method can also include receiving a response to the second RPC and forwarding the response to the second service at the second port.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is a block diagram of a virtual computing system, in accordance with some embodiments of the present disclosure.

FIG. 2A is a block diagram of a computing environment in which remote procedure calls (RPCs) are used, in accordance with some embodiments of the present disclosure.

FIG. 2B is a block diagram of a computing environment in which an RPC broker facilitates processing of RPCs, in accordance with some embodiments of the present disclosure.

FIG. 2C is a block diagram of the RPC broker of FIG. 2B, in accordance with some embodiments of the present disclosure.

FIG. 2D is a block diagram of another computing environment in which an RPC broker facilitates processing of RPCs, in accordance with some embodiments of the present disclosure.

FIG. 2E is a block diagram of an RPC broker according to yet another embodiment.

FIG. 3 is a flowchart of an example method for processing RPCs, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to a virtual computing system having a plurality of clusters, with each cluster having a plurality of nodes. Each of the plurality of nodes can include one or more virtual machines managed by an instance of a hypervisor. Together, the clusters and the individual nodes can be used to improve performance for network users. For example, the clusters and individual nodes can provide functionality such as efficient provisioning of new virtual machines, load balancing for network traffic, delivery of remotely hosted computer applications, and efficient storage of large amounts of data.

To provide such functionality, the nodes may execute various services. In some instances, the nodes may be configured to interact with the services provided by other nodes. Additionally, services within the same node may be configured to interact with one another. For example, the services on the same node or on different nodes may interact with one another through the use of remote procedure calls (RPCs). Generally, an RPC can be an interaction in which a first service transmits a message to a second service requesting that the second service perform a specified procedure, subroutine, method, or other set of instructions. The message can include various parameters for the specified procedure. After the second service has performed the requested procedure, the second service can transmit the results of the procedure back to the first service. In this way, a service may take advantage of the functionality of another services, which may exist on the same node or on different nodes across the network, resulting in an efficient distributed computing architecture.

Many such systems can be relatively complex. For example, a system may include hundreds, thousands, or millions of nodes that communicate with each other via a network. Each node may execute any number of services. As a result, the interactions between the services in such a system can be difficult to accurately simulate prior to deployment of the network. This can lead to difficulties in testing the system to ensure reliability prior to deployment. Similarly, the complexity can also make it challenging to debug the system after it has been deployed. This disclosure aims to simplify the simulation and testing of the complex RPC interactions in such a system by providing an RPC broker.

An RPC broker can serve as a proxy or router for any service provided by a node. Generally, the RPC broker can intercept RPCs and their associated responses sent between a first service and a second service. The RPC broker can be implemented in a manner that is transparent to both the first service and the second service. That is, although the RPC broker can intercept an RPC and its response, both of the services involved in the RPC interaction can function as if they were communicating directly with one another. Thus, the RPC broker can be implemented without requiring any change to the manner in which the services initiate and respond to RPCs with one another.

In some embodiments, a single RPC broker can broker the RPC interactions between a large number of services, which may be distributed across any number of nodes. As described above, in some configurations, the RPC broker can intercept RPCs and their responses in a manner that does not impact the overall functionality of the collection of nodes. However, because all of the RPCs pass through the RPC broker, the RPC broker can store a record of the RPCs and other associated analytics, such as the processing time for each RPC, which can be provided to a network administrator to allow the network administrator to better understand the workflow of RPCs in the network. In some embodiments, the RPC broker can also be configured to override some of the services associated with the RPCs it intercepts. This can be useful for debugging purposes. For example, to test how a requesting service handles a particular type of response to an RPC (e.g., an error code or other predetermined value), the RPC broker can intercept the RPC and can automatically transmit a response having the predetermined value back to the requesting service. The requesting service can then be observed to evaluate its handling of the response having the predetermined value. Thus, the RPC broker can allow easier observability and more efficient testing of the system without requiring any change to the functionality of the nodes or services themselves. These and other aspects of the disclosure are described in greater detail below.

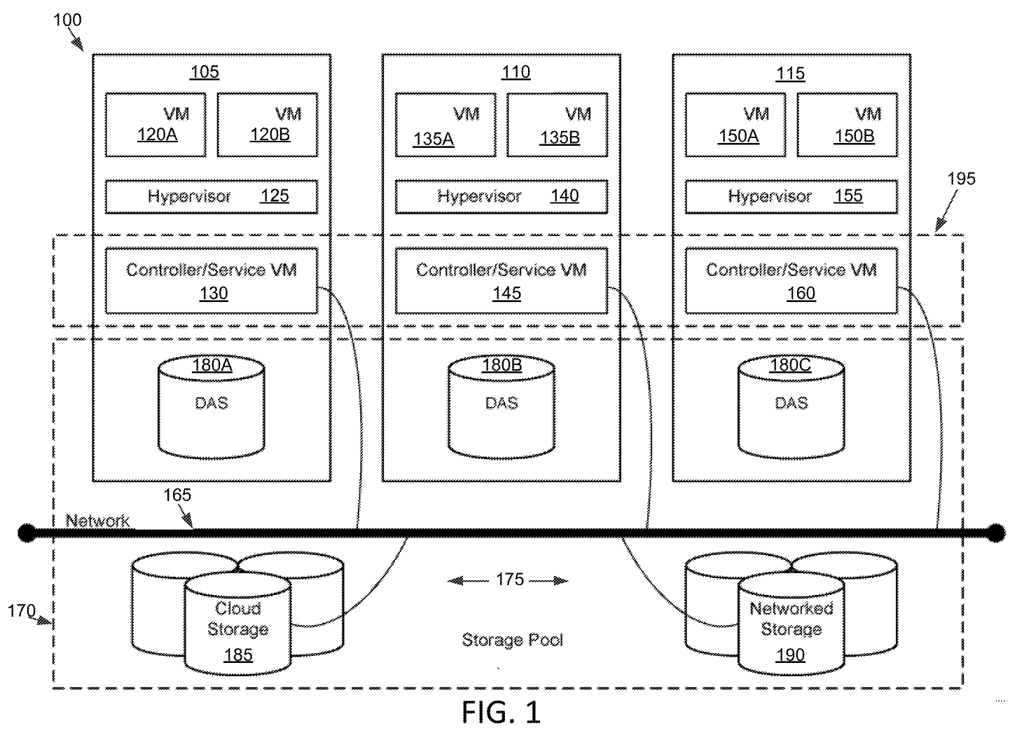

Referring now to FIG. 1, a virtual computing system 100 is shown, in accordance with some embodiments of the present disclosure. The virtual computing system 100 includes a plurality of nodes, such as a first node 105, a second node 110, and a third node 115. The first node 105 includes user virtual machines (“user VMs”) 120A and 120B (collectively referred to herein as “user VMs 120”), a hypervisor 125 configured to create and run the user VMs, and a controller/service VM 130 configured to manage, route, and otherwise handle workflow requests between the various nodes of the virtual computing system 100. Similarly, the second node 110 includes user VMs 135A and 135B (collectively referred to herein as “user VMs 135”), a hypervisor 140, and a controller/service VM 145, and the third node 115 includes user VMs 150A and 150B (collectively referred to herein as “user VMs 150”), a hypervisor 155, and a controller/service VM 160. The controller/service VM 130, the controller/service VM 145, and the controller/service VM 160 are all connected to a network 165 to facilitate communication between the first node 105, the second node 110, and the third node 115. Although not shown, in some embodiments, the hypervisor 125, the hypervisor 140, and the hypervisor 155 may also be connected to the network 165.

The virtual computing system 100 also includes a storage pool 170. The storage pool 170 may include network-attached storage 175 and direct-attached storage 180A, 180B, and 180C. The network-attached storage 175 may be accessible via the network 165 and, in some embodiments, may include cloud storage 185, as well as local storage area network 190. In contrast to the network-attached storage 175, which is accessible via the network 165, the direct-attached storage 180A, 180B, and 180C may include storage components that are provided within each of the first node 105, the second node 110, and the third node 115, respectively, such that each of the first, second, and third nodes may access its respective direct-attached storage without having to access the network 165.

It is to be understood that only certain components of the virtual computing system 100 are shown in FIG. 1. Nevertheless, several other components that are needed or desired in the virtual computing system to perform the functions described herein are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater than or fewer than three nodes may be used. Likewise, although only two of the user VMs (e.g., the user VMs 120, the user VMs 135, and the user VMs 150) are shown on each of the respective first node 105, the second node 110, and the third node 115, in other embodiments, the number of the user VMs on each of the first, second, and third nodes may vary to include either a single user VM or more than two user VMs. Further, the first node 105, the second node 110, and the third node 115 need not always have the same number of the user VMs (e.g., the user VMs 120, the user VMs 135, and the user VMs 150). Additionally, more than a single instance of the hypervisor (e.g., the hypervisor 125, the hypervisor 140, and the hypervisor 155) and/or the controller/service VM (e.g., the controller/service VM 130, the controller/service VM 145, and the controller/service VM 160) may be provided on the first node 105, the second node 110, and/or the third node 115.

In some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100. In some embodiments, the virtual computing system 100 may be part of a data center.

Each of the first node 105, the second node 110, and the third node 115 may also be configured to communicate and share resources with each other via the network 165. For example, in some embodiments, the first node 105, the second node 110, and the third node 115 may communicate and share resources with each other via the controller/service VM 130, the controller/service VM 145, and the controller/service VM 160, and/or the hypervisor 125, the hypervisor 140, and the hypervisor 155. One or more of the first node 105, the second node 110, and the third node 115 may also be organized in a variety of network topologies, and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 170, as well as with other elements of the first node 105, the second node 110, and the third node 115 to receive, send, and process information, and to control the operations of the underlying first, second, or third node. The processing units may retrieve a set of instructions from the storage pool 170, such as, from a permanent memory device like a read only memory (ROM) device and copy the instructions in an executable form to a temporary memory device that is generally some form of random access memory (RAM). The ROM and RAM may both be part of the storage pool 170, or in some embodiments, may be separately provisioned from the storage pool. Further, the processing units may include a single stand-alone processing unit, or a plurality of processing units that use the same or different processing technology.

With respect to the storage pool 170 and particularly with respect to the direct-attached storage 180A, 180B, and 180C, each of the direct-attached storage may include a variety of types of memory devices. For example, in some embodiments, one or more of the direct-attached storage 180A, 180B, and 180C may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 175 may include any of a variety of network accessible storage (e.g., the cloud storage 185, the local storage area network 190, etc.) that is suitable for use within the virtual computing system 100 and accessible via the network 165. The storage pool 170 including the network-attached storage 175 and the direct-attached storage 180A, 180B, and 180C may together form a distributed storage system configured to be accessed by each of the first node 105, the second node 110, and the third node 115 via the network 165, the controller/service VM 130, the controller/service VM 145, and the controller/service VM 160, and/or the hypervisor 125, the hypervisor 140, and the hypervisor 155. In some embodiments, the various storage components in the storage pool 170 may be configured as virtual disks for access by the user VMs 120, the user VMs 135, and the user VMs 150.

Each of the user VMs 120, the user VMs 135, and the user VMs 150 is a software-based implementation of a computing machine in the virtual computing system 100. The user VMs 120, the user VMs 135, and the user VMs 150 emulate the functionality of a physical computer. Specifically, the hardware resources, such as processing unit, memory, storage, etc., of the underlying computer (e.g., the first node 105, the second node 110, and the third node 115) are virtualized or transformed by the respective hypervisor 125, the hypervisor 140, and the hypervisor 155, respectively, into the underlying support for each of the user VMs 120, the user VMs 135, and the user VMs 150 that may run its own operating system and applications on the underlying physical resources just like a real computer. By encapsulating an entire machine, including CPU, memory, operating system, storage devices, and network devices, the user VMs 120, the user VMs 135, and the user VMs 150 are compatible with most standard operating systems (e.g. Windows, Linux, etc.), applications, and device drivers. Thus, each of the hypervisor 125, the hypervisor 140, and the hypervisor 155 is a virtual machine monitor that allows a single physical server computer (e.g., the first node 105, the second node 110, third node 115) to run multiple instances of the user VMs 120, the user VMs 135, and the user VMs 150, with each user VM sharing the resources of that one physical server computer, potentially across multiple environments. By running the user VMs 120, the user VMs 135, and the user VMs 150 on each of the first node 105, the second node 110, and the third node 115, respectively, multiple workloads and multiple operating systems may be run on a single piece of underlying hardware computer (e.g., the first node, the second node, and the third node) to increase resource utilization and manage workflow.

The user VMs 120, the user VMs 135, and the user VMs 150 are controlled and managed by their respective instance of the controller/service VM 130, the controller/service VM 145, and the controller/service VM 160. The controller/service VM 130, the controller/service VM 145, and the controller/service VM 160 are configured to communicate with each other via the network 165 to form a distributed system 195. Each of the controller/service VM 130, the controller/service VM 145, and the controller/service VM 160 may also include a local management system (e.g., Prism Element from Nutanix, Inc.) configured to manage various tasks and operations within the virtual computing system 100. For example, as discussed below, in some embodiments, the local management system of the controller/service VM 130, the controller/service VM 145, and the controller/service VM 160 may facilitate conversion of the hypervisor 125, the hypervisor 140, and the hypervisor 155 from a first hypervisor type to a second hypervisor type. The local management system may also manage the reconfiguration of the other components due to the conversion of the hypervisor.

The hypervisor 125, the hypervisor 140, and the hypervisor 155 of the first node 105, the second node 110, and the third node 115, respectively, may be configured to run virtualization software, such as, ESXi from VMWare, AHV from Nutanix, Inc., XenServer from Citrix Systems, Inc., etc., for running the user VMs 120, the user VMs 135, and the user VMs 150, respectively, and for managing the interactions between the user VMs and the underlying hardware of the first node 105, the second node 110, and the third node 115. Each of the controller/service VM 130, the controller/service VM 145, the controller/service VM 160, the hypervisor 125, the hypervisor 140, and the hypervisor 155 may be configured as suitable for use within the virtual computing system 100.

The network 165 may include any of a variety of wired or wireless network channels that may be suitable for use within the virtual computing system 100. For example, in some embodiments, the network 165 may include wired connections, such as an Ethernet connection, one or more twisted pair wires, coaxial cables, fiber optic cables, etc. In other embodiments, the network 165 may include wireless connections, such as microwaves, infrared waves, radio waves, spread spectrum technologies, satellites, etc. The network 165 may also be configured to communicate with another device using cellular networks, local area networks, wide area networks, the Internet, etc. In some embodiments, the network 165 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. The leader node may also be configured to receive and handle requests (e.g., user requests) from outside of the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 170 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120, the user VMs 135, and the user VMs 150 that are part of a cluster are configured to share resources with each other. In some embodiments, multiple clusters may share resources with one another.

Further, in some embodiments, although not shown, the virtual computing system 100 includes a central management system (e.g., Prism Central from Nutanix, Inc.) that is configured to manage and control the operation of the various clusters in the virtual computing system. In some embodiments, the central management system may be configured to communicate with the local management systems on each of the controller/service VM 130, the controller/service VM 145, the controller/service VM 160 for controlling the various clusters.

Again, it is to be understood again that only certain components of the virtual computing system 100 are shown and described herein. Nevertheless, other components that may be needed or desired to perform the functions described herein are contemplated and considered within the scope of the present disclosure. It is also to be understood that the configuration of the various components of the virtual computing system 100 described above is only an example and is not intended to be limiting in any way. Rather, the configuration of those components may vary to perform the functions described herein.

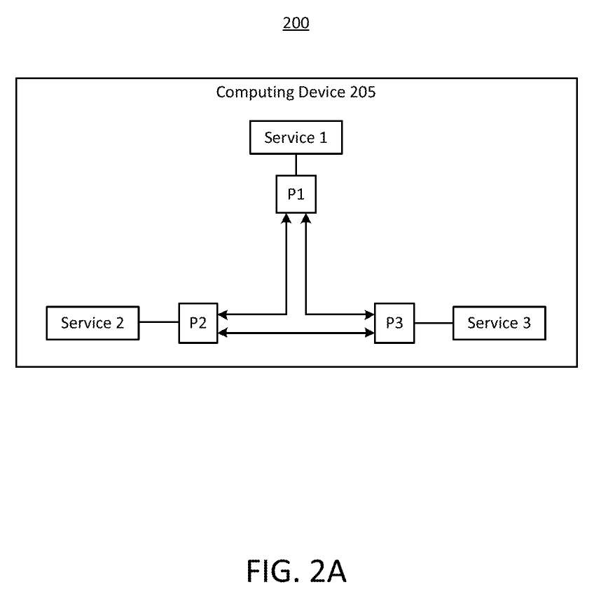

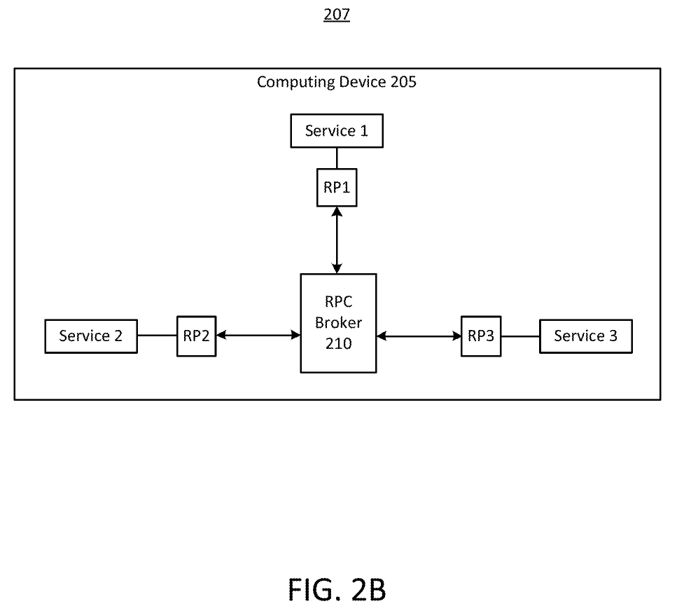

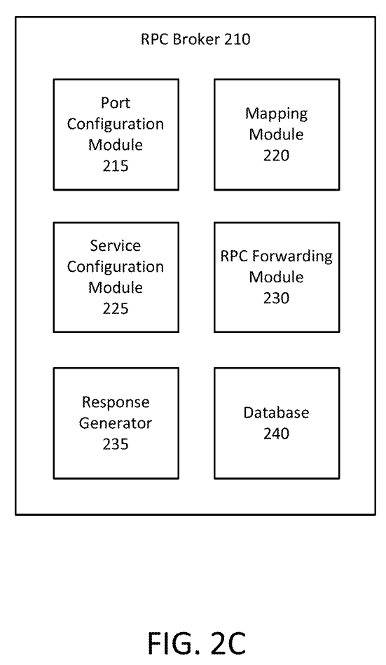

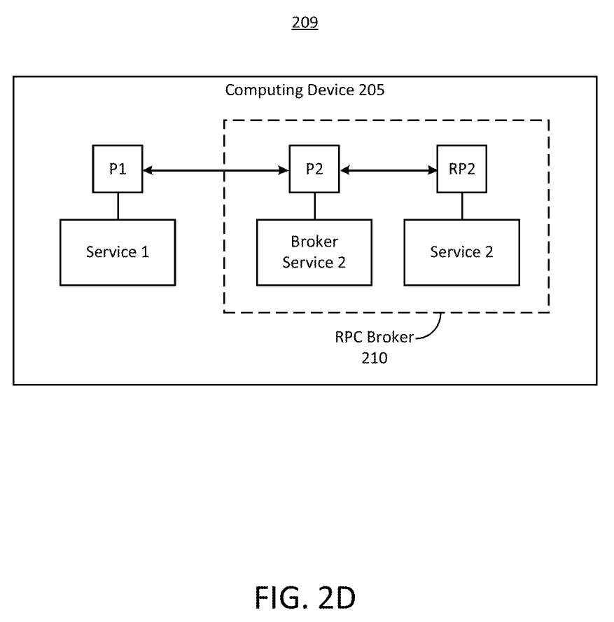

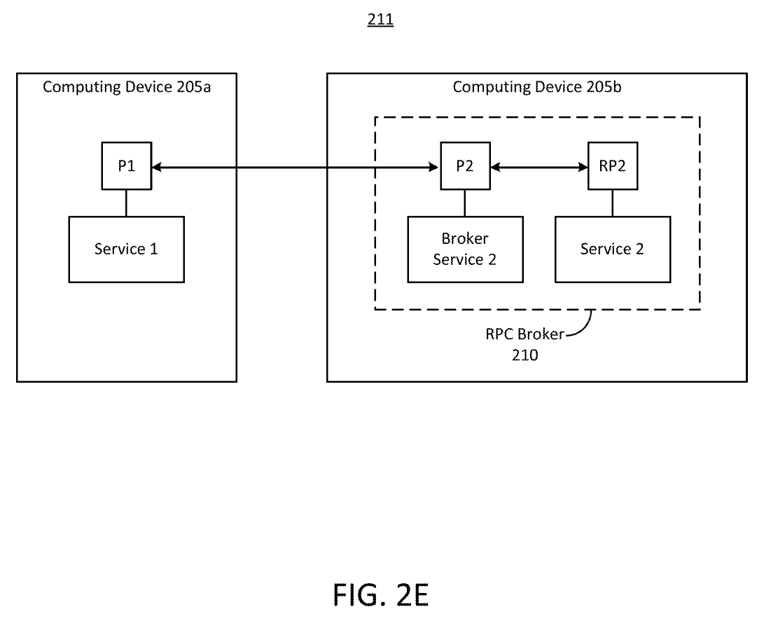

FIG. 2A is a block diagram of a computing environment 200 in which remote procedure calls (RPCs) are used, in accordance with some embodiments of the present disclosure. The computing environment includes a computing device 205. Computing device 205 executes service 1, which is available via port P1. Computing device 205 also executes service 2, which is available via port P2 and service 3, which is available via port P3.

Each of the services 1-3 can be any application executing on the computing device 205 to provide a capability relating to data storage, data manipulation, data presentation, and the like. The services 1-3 can be invoked via an RPC sent to their respective ports P1-P3. In the environment 200, the respective ports P1-P3 of the computing device 205 are coupled directly to one another. As a result, the services 1-3 can invoke the functionality of one another by transmitting RPCs directly to the desired ports P1-P3. For example, service 1 or service 2 can invoke service 3 by sending an RPC to P3. Similarly, service 1 or service 3 can invoke service 2 by sending an RPC to P2, and service 2 or service 3 can invoke service 1 by sending an RPC to P1.

In some embodiments, the computing device 205 may correspond to any of the virtual machines 120, 135, or 150 shown in FIG. 1, or to the computing devices 105, 110, 115 shown in FIG. 1. It should be understood that the environment 200 is simplified for illustrative purposes, but in practice may include any number of services, each of which may execute be accessible via a respective port of the computing device 205. Due to the potential volume of services, it can be difficult to simulate the RPC interactions that may take place in the computing device 205 in a manner that allows for quick and reliable testing of the environment 200.

FIG. 2B is a block diagram of a computing environment 207 in which an RPC broker 210 facilitates processing of RPCs, in accordance with some embodiments of the present disclosure. The environment 207 represents a modification to the environment 200 of FIG. 2 in which the computing device 205 includes the addition of an RPC broker 210. Generally, the services 1-3 can communicate with one another via the RPC broker 210, rather than directly. FIG. 2C is a block diagram of the RPC broker 210 of FIG. 2B, in accordance with some embodiments of the present disclosure. FIGS. 2B and 2C are described together below.

The RPC broker 210 facilitates RPC interactions between the services 103 executing within the computing device 205 in a manner that is transparent to the services 1-3. That is, the functionality of the services 103 need not be changed to allow for RPC interactions between them to be brokered by the RPC broker 210, and in fact the services 103 may not even be required to have awareness of the presence of the RPC broker 210. As a result, the functionality of the services 103 individually, and of the environment 207 as a whole, can be essentially the same as the functionality of the services 103 and the environment 200 of FIG. 2A. However, the addition of the RPC broker 210 can allow for additional functionality, such as the ability to easily override selected RPCs and the ability to more easily collect data relating to RPC interactions for testing and debugging purposes.

To provide this functionality, the RPC broker 210 can reconfigure certain aspects of the computing device 205. For example, the RPC broker 210 can halt execution of the services 1-3 at their default ports P1-P3 shown in FIG. 2A. In some embodiments, the port configuration module 215 can determine the default ports associated with the services 1-3, and the service configuration module 225 can communicate directly with each respective port to transmit a request to halt the execution of the each of the services 1-3 and the respective ports P1-P3. After the services 1-3 have been halted at their default ports P1-P3, the port configuration module 215 can select a respective redirect port for each of the services 1-3. In the environment 207, the port configuration module 215 has selected port RP1 as the redirect port for service 1, port RP2 as the redirect port for service 2, and port RP3 as the redirect port for service 3. The service configuration module 225 can then cause each computing device 205 to restart the services 1-3 at the respective selected redirect ports RP1-RP3. Thus, service 1 is restarted and becomes accessible via redirect port RP1, service 2 is restarted and becomes accessible via redirect port RP2, and service 3 is restarted and becomes accessible via redirect port RP3. In some embodiments, the mapping module 220 can be configured to store a mapping of the ports P1-P3 and their respective redirect ports RP1-RP3. Thus, the stored mapping can record an association between the default port P1 for service 1 and its respective redirect port RP1, as well as associations between the default port P2 for service 2 and its respective redirect port RP2, and the default port P3 for service 3 and its respective redirect port RP3. The mapping stored by the mapping module 220 can allow the RPC broker 210 to correctly forward RPCs after the service configuration module 225 has reconfigured the ports of the computing device 205 to cause the services 1-3 to be accessible via the redirect ports RP1-RP3, rather than the default ports P1-P3.

In some embodiments, the RPC broker 210 can serve as a router for all of the RPC interactions between the services 1-3. The RPC broker 210 can forward an RPC to the corresponding redirect port in a manner that allows each of the services 103 to function as if the port reconfiguration has not occurred. For example, the RPC broker 210 can receive an RPC from service 1 intended to invoke service 2. Because service 1 is not aware of the port reconfiguration performed by the RPC broker 210, the RPC will indicate an intended destination of P2. Upon receipt of the RPC, the RPC forwarding module 230 can examine the destination port specified in the RPC and can refer to the mapping stored by the mapping module 220 to determine that redirect port RP2 is associated with the original intended destination port P2. The RPC forwarding module 230 can then forward the RPC to the redirect port RP2, such that service 2 can be invoked as intended. Upon receiving a response from service 2, the RPC forwarding module 230 can also forward the response back to service 1. Thus, the RPC interaction is performed as intended from the perspective of both service 1 and service 2.

It should be understood that the RPC forwarding module 230 can be configured to process any number of RPCs from any of the services 1-3 in the manner described above. In some embodiments, the RPC forwarding module 230 can also store information relating to each of the RPCs it receives in the database 240 for future use. For example, the RPC forwarding module 230 can be configured to determine a processing time for each RPC based on the time that elapses between receipt of the RPC from the originating service and receipt of the response from the destination service. The RPC forwarding module 230 can then store a record of the RPC and its processing time in the database, along with other metrics, such as any parameters included in the RPC, the time at which the RPC was generated, parameters received in the response to the RPC, etc.

Over time, the database 240 can serve as a centralized location for recorded metrics for a large volume of RPCs, which can be examined by analytical tools for debugging purposes, for example. In some embodiments, the RPC forwarding module 230 can also be configured to store such information relating to all of the RPCs that are invoked in response to a particular operation performed in the environment 207. For example, an operation such as a data manipulation operation may involve the invocation of several RPCs between the services 1-3. The RPC forwarding module 230 can store metrics for each of these RPCs in the database 240 to allow a network administrator to determine all of the RPCs involved in the execution of the operation, thereby providing greater insight into the underlying interactions between the services 1-3 that occur during the performance of a specified operation in the environment 207.

In some embodiments, the RPC broker 210 can also be configured to override one or more RPCs. For example, overriding an RPC can be a useful way for an administrator to test the ability of a service to handle a predetermined result for an RPC, such as for edge case testing or testing of error handling capabilities. Thus, in some embodiments, rather than forwarding a received RPC to its intended destination and providing the response back to the originating service, the response generator 235 can be configured to inject a predetermined value into a response and to provide the response having the predetermined value back to the originating service. In some embodiments, the database 240 can store a set of rules or policies indicating which RPCs should be overridden. For example, such rules or policies may indicate that an RPC should be overridden based on criteria such as the originating service, the destination service, or a value of a parameter included in the RPC request. The database 240 can also store one or more predetermined values to be provided in response to each RPC that is to be overridden. By examining a received RPC and referencing the rules or policies stored in the database 240, the response generator 235 can determine whether an RPC is to be overridden and, if so, can provide a response to the originating service along with one or more predetermined values. In such embodiments, rather than forwarding the RPC to the intended destination service, the response generator 235 can simply discard the RPC. Thus, by selecting appropriate policies or rules, a network administrator can configure the RPC broker 210 to override any desired RPC interactions in the environment 207.

It should be understood that the particular implementations of the RPC broker 210 shown in FIGS. 2B and 2C are illustrative only. For example, while the RPC broker 210 can be conceptualized as a single module within the computing device 205, other implementations are possible without departing from the scope of this disclosure. In some embodiments, the RPC broker 210 itself can be implemented in a distributed fashion, and may be or may include a plurality of broker services having functionality similar to the services 1-3 shown in FIG. 2B. For example, in some embodiments, the RPC broker 210 can perform the functionality described above using broker services communicatively coupled to each of the original ports P1-P3 assigned to the services 1-3. Thus, a first broker service can listen on port P1 for an RPC from another service that was destined for service 1. Then, when the first broker service receives an RPC on port P1, the first broker service can forward the RPC to port RP1, on which service 1 has been restarted. Similarly a second broker service can be started on port P2 to listen for RPCs directed to service 2 and to forward received RPCs to the redirect port RP2, and a third broker service can be started on port P3 to listen for RPCs directed to service 3 and to forward received RPCs to the redirect port RP3. In some implementations, the first broker service, the second broker service, and the third broker service can be managed by the service configuration module 225. Together, the first broker service, the second broker service, and the third broker service can implement some of the functionality described above with respect to the RPC broker 210.

FIG. 2D is a block diagram of another computing environment 209 in which an RPC broker 210 facilitates processing of RPCs, in accordance with some embodiments of the present disclosure. Like the environment 207 of FIG. 2B, the environment 209 includes the computing device 205. For illustrative purposes, only two services (labeled service 1 and service 2) are shown executing on the computing device 205. As described above, under normal operation in the absence of the RPC broker 210, service 1 would be accessible via port P1 and service 2 would be accessible via port P2. However, the RPC broker 210 has reconfigured service 2 to be accessible via port RP2, in a manner similar to that described above in connection with FIGS. 2B and 2C. The RPC broker 210 also initiates broker service 2 on port P2. Thus, when service 1 requires functionality provided by service 2, service 1 sends an RPC to port P2. The RPC is received by broker service 2, which forwards the RPC to the redirect port RP2 on which original service 2 has been restarted. Service 2 then provides a response to the RPC back to port P2, and broker service 2 forwards the response to service 1 via port P1. Alternatively, if the RPC broker 210 maintains a policy indicating that the RPC received from service 1 should be overridden, the RPC broker 210 may simply discard the RPC received from service 1 and may provide a response having one or more predetermined values as generated by the response generator 235 of FIG. 2C. In either case, from the perspective of service 1, the RPC interaction is unchanged by the presence of the RPC broker 210.

It should be understood that, while the RPC broker 210 is shown in FIG. 2D as brokering RPCs destined only for service 2, in other embodiments, the RPC broker 210 can also be configured to broker RPCs destined for service 1 (or any other service that may be executing on the computing device 205). In addition, in some embodiments, the RPC broker 210 can perform similar functionality with respect to RPCs received from services that may be executing outside of the computing device on which the RPC broker resides. An example of such an embodiment is shown in the computing environment 211 of FIG. 2E, in which service 1 executes on a computing device 205a and is accessible via port P1, while the RPC broker 210 resides on a separate computing device 205b. As in the example of FIG. 2D, the RPC broker 210 in the environment 211 of FIG. 2E has reconfigured service 2 to execute on redirect port RP2 of the computing device 205b, while broker service 2 executes on the original port P2 for service 2. The functionality of the RPC broker 210 in FIG. 2E is similar to that described above. For example, when service 1 requires functionality provided by service 2, service 1 sends an RPC from port P1 of the computing device 205a to port P2 of the computing device 205b. The RPC is received by broker service 2, which forwards the RPC to the redirect port RP2 on which original service 2 has been restarted. Service 2 then provides a response to the RPC back to port P2, and broker service 2 forwards the response to service 1 via port P1. Alternatively, if the RPC broker 210 maintains a policy indicating that the RPC received from service 1 should be overridden, the RPC broker 210 may discard the RPC received from service 1 and may instead provide a response having one or more predetermined values as generated by the response generator 235 of FIG. 2C.

FIGS. 2A-2E depict various alternative implementations of computing environments including an RPC broker 210. However, a person of ordinary skill in the art will understand that other variations are possible without departing from the scope of this disclosure. For example, a computing environment may include any number of computing devices similar to the computing devices 205a and 205b, each of which may execute various services. Similarly, each computing device may include one or more RPC brokers similar to the RPC broker 210. For example, in some implementations, the computing devices executing RPC brokers may each represent one of the nodes 105 or one of the VMs 120 depicted in FIG. 1, which are interconnected to allow their various services to communicate with one another via RPC interactions.

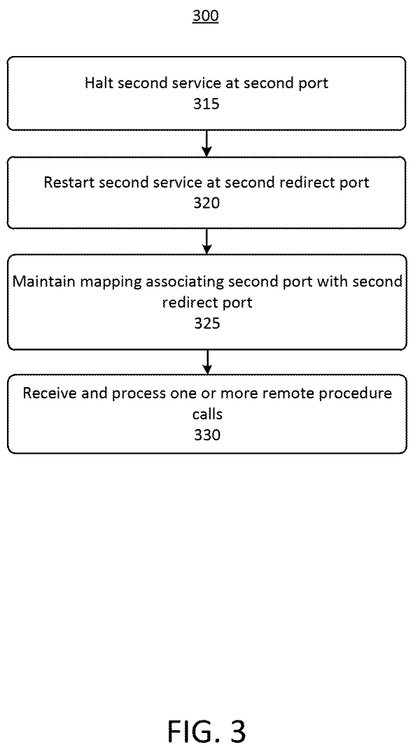

FIG. 3 is a flowchart of an example method 300 for processing RPCs, in accordance with some embodiments of the present disclosure. In some embodiments, the method 300 can be performed by the RPC broker 210 described above within a system of one or more processors that execute at least a first service accessible via a first port and a second service accessible via a second port. In brief overview, the method 300 includes halting the second service accessible via the second port (step 305), restarting the second service at a second redirect port (step 310), maintaining a mapping associating the second port with the second redirect port (step 315), and receiving and processing one or more RPCs (step 320).

Referring again to FIG. 3, the method 300 the method 300 includes halting a second service accessible via a second port of a second computing device (step 305). In some embodiments, the RPC broker 210 can include a port configuration module 215 configured to determine the second port associated with the second service, and a service configuration module 225 configured to halt the second service at the second port. The port configuration module 215 can select a second redirect port on the same computing device as the second port, and the service configuration module 225 can restart the second service at the second redirect port (step 310).

The method 300 includes maintaining a mapping associating the second port with the second redirect port (step 315). In some embodiments, the RPC broker 210 can include a mapping module 220 configured to generate the mapping. The mapping module 220 can store the mapping in a database, such as the database 240. In some embodiments, the method 300 can also include halting the first service accessible via the first port, selecting a first redirect port, and restarting the first service at the first redirect port.

The method 300 includes receiving and processing one or more RPCs (step 320). In some embodiments, an RPC may be processed in a manner that allows the RPC to be executed by the destination service and the response delivered back to the requesting service without requiring that either the destination service or the requesting service have knowledge of the reconfiguration performed in steps 305 and 310. In some embodiments, the requesting service can be the first service, which may execute on a first computing device on which the first port and first redirect port are included. The destination service can be the second service executing on a second computing device on which the second port and second redirect port are included. In some other embodiments, the first and second services (and their respective ports) may execute on the same computing device.

The RPC broker 210 can include an RPC forwarding module 230 configured to receive an RPC from the requesting service. The RPC forwarding module 230 can determine that the intended destination is the second port, and can refer to the mapping to determine that the second port is mapped to the second redirect port on which the second service has been restarted. The RPC forwarding module 230 can then forward the RPC to the second redirect port, and can receive a response to the RPC from the second service. The RPC forwarding module 230 can then forward the response back to the requesting service. In some embodiments, the RPC forwarding module 230 can also store metrics for the RPC in the database 240.

In some other embodiments, the RPC broker 210 can instead be configured to override a received RPC. For example, rather than forwarding a received RPC to its intended destination service, the RPC broker 210 can discard the RPC and can provide a response that includes a predetermined value to the requesting service. For example, the RPC broker 210 can include a response generator 235 configured to generate the response including the predetermined value. In some embodiments, the response generator 235 can determine that the received RPC should be overridden based on one or more rules or policies stored in the database 240. For example, such rules or policies may indicate that an RPC should be overridden based on an identification of the requesting service, an identification of the destination service, or a parameter included in the RPC. The database 240 may also indicate the predetermined value that should be included in a response to an overridden RPC. The response generator 235 can retrieve the predetermined value and can generate a response including the predetermined value, which can then be provided back to the requesting service. Thus, the RPC broker 210 can allow easier observability and more efficient testing of the system without requiring any change to the functionality of the services themselves.

Although the present disclosure has been described with respect to software applications, in other embodiments, one or more aspects of the present disclosure may be applicable to other components of the virtual computing system 100 that may be suitable for real-time monitoring by the user.

It is also to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. An apparatus comprising a processor communicatively coupled to each of a first port associated with a first service and a second port associated with a second service, the processor having programmed instructions to:
halt the second service at the second port;
restart the second service at a second redirect port; and
maintain a mapping associating the second port with the second redirect port.

2. The apparatus of claim 1, wherein the processor further has programmed instructions to forward a first remote procedure call (RPC) initiated by the first service at the first port and directed to the second service at the second port by:
receiving the first RPC from the first service via the first port;
forwarding the first RPC to the second redirect port, based on the mapping;
receiving a response to the first RPC; and
forwarding the response to the first service at the first port.

3. The apparatus of claim 2, wherein the processor further has programmed instructions to:
determine a processing time for the first RPC, wherein the processing time corresponds to an elapsed time between receipt of the first RPC by the processor and receipt of the response by the processor; and
store a record of the first RPC and the processing time of the first RPC in a database.

4. The apparatus of claim 1, wherein the processor further has programmed instructions to:
halt the first service at the first port;
restart the first service at a first redirect port; and
maintain the mapping associating the first port with the first redirect port.

5. The apparatus of claim 1, wherein the processor further has programmed instructions to forward a second RPC initiated by the second service at the second port and directed to the first service at the first port by:
receiving the second RPC from the second service via the second port;
forwarding the second RPC to a first redirect port, based on the mapping;
receiving a response to the second RPC; and
forwarding the response to the second service at the second port.

6. The apparatus of claim 1, wherein the processor further has programmed instructions to:
receive a plurality of first RPCs initiated by the first service directed to the second service and a plurality of second RPCs initiated by the second service directed to the first service; and
store a record of the plurality of first RPCs and the plurality of second RPCs.

7. The apparatus of claim 1, wherein the processor further has programmed instructions to:
receive a first RPC initiated by the first service and directed to the second service;
discard the first RPC; and
transmit a predetermined response to the first service via the first port.

8. The apparatus of claim 7, wherein the predetermined response corresponds to an error code associated with the first RPC.

9.-12. (canceled)

13. A computer-implemented method executed by a processor communicatively coupled to a first service via a first port and to a second service via a second port, the method comprising:
halting the second service at the second port;
restarting the second service at a second redirect port; and
maintaining a mapping associating the second port with the second redirect port.

14. The method of claim 13, further comprising forwarding, by the processor, a first RPC initiated by the first service directed to the second service at the second port by:
receiving the first RPC from the first service via the first port;
forwarding the first RPC to the second redirect port, based on the mapping;
receiving a response to the first RPC; and
forwarding the response to the first service at the first port.

15. The method of claim 14, further comprising:
determining, by the processor, a processing time for the first RPC, wherein the processing time corresponds to an elapsed time between receipt of the first RPC by the processor and receipt of the response by the processor; and
storing, by the processor, a record of the first RPC and the processing time of the first RPC in a database.

16. The method of claim 13, further comprising:
halting the first service at the first port;
restarting the first service at a first redirect port; and
maintain the mapping associating the first port with the first redirect port.

17. The method of claim 13, further comprising forwarding, by the processor, a second RPC initiated by the second service directed to the first service at the first port by:
receiving the second RPC from the second service via the second port;
forwarding the second RPC to a first redirect port, based on the mapping;
receiving a response to the second RPC; and
forwarding the response to the second service at the second port.

18. The method of claim 13, further comprising:
receiving, by the processor, a plurality of first RPCs initiated by the first service directed to the second service and a plurality of second RPCs initiated by the second service directed to the first service; and
storing, by the processor, a record of the plurality of first RPCs and the plurality of second RPCs.

19. The method of claim 13, further comprising:
receiving, by the processor, a first RPC initiated by the first service and directed to the second service;
discarding, by the processor, the first RPC; and
transmitting, by the processor, a predetermined response to the first service via the first port.

20. The method of claim 19, wherein the predetermined response corresponds to an error code associated with the first RPC.

21. A non-transitory computer-readable storage medium having instructions encoded thereon which, when executed by a processor communicatively coupled to a first service via a first port and to a second service via a second port, cause the processor to perform a method comprising:
halting the second service at the second port;
restarting the second service at a second redirect port; and
maintaining a mapping associating the second port with the second redirect port.

22. The non-transitory computer-readable storage medium of claim 21, wherein the method further comprises forwarding a first RPC initiated by the first service at the first port and directed to the second service at the second port by:
receiving the first RPC from the first service via the first port;
forwarding the first RPC to the second redirect port, based on the mapping;
receiving a response to the first RPC; and
forwarding the response to the first service at the first port.

23. The non-transitory computer-readable storage medium of claim 22, wherein the method further comprises:
determining a processing time for the first RPC, wherein the processing time corresponds to an elapsed time between receipt of the first RPC by the processor and receipt of the response by the processor; and
storing a record of the first RPC and the processing time of the first RPC in a database.

24. The non-transitory computer-readable storage medium of claim 21, the method further comprising:
halting the first service at the first port;
restarting the first service at a first redirect port; and
maintaining the mapping associating the first port with the first redirect port.

25. The non-transitory computer-readable storage medium of claim 21, wherein the method further comprises forwarding a second RPC initiated by the second service at the second port and directed to the first service at the first port by:
receiving the second RPC from the second service via the second port;
forwarding the second RPC to the first redirect port, based on the mapping;
receiving a response to the second RPC; and
forwarding the response to the second service at the second port.

26. The non-transitory computer-readable storage medium of claim 21, the method further comprising:
receiving a plurality of first RPCs initiated by the first service directed to the second service and a plurality of second RPCs initiated by the second service directed to the first service; and
storing a record of the plurality of first RPCs and the plurality of second RPCs.

27. The non-transitory computer-readable storage medium of claim 21, the method further comprising:
receiving a first RPC initiated by the first service and directed to the second service;
discarding the first RPC; and
transmitting a predetermined response to the first service via the first port.

28. The non-transitory computer-readable storage medium of claim 27, wherein the predetermined response corresponds to an error code associated with the first RPC.
